(19) United States
(12) Patent Application Publication
(10) Pub. No.: US 2005/0039605 A1
(43) Pub. Date: Feb. 24, 2005

(54) Method and device for producing sparking alcohol-containing beverages

(76) Inventor: Georgi Asenov Michev, Plovdid (BG)

Correspondence Address: BROWN & MICHAELS, PC;400 M & T BANK BUILDING, 118 NORTH TIOGA ST, ITHACA, NY, 14850, US

(21) Appl. No.: 10/500,392

(22) PCT Filed: Nov. 21, 2002
(86) PCT No.: PCT/BG02/00029

(30) Foreign Application Priority Data
Dec. 29, 2001 (BG) 106273

(51) Int. Cl. A23L 1/00

(52) U.S. Cl. 99/275

(57) ABSTRACT

The method consists either of preparation of a base mix, which is subjected to controlled alcohol fermentation or of preparation of a non-stabilized, non-bubbly and unfiltered alcohol-containing beverage which is subjected to carbonation, both processes followed by, stabilization and filtration, all carried out in one and the same air-tight space. The beverage remains there until consumption, when the filtration and stabilization are carried out simultaneously. The device consists of a container (1) with upper (14) and lower (15) end parts. In the center of the upper end part (14) a multifunctional plug head (3) is fixed. Its lower end is fixed to a piping (4). The lower open end of the piping (4) is placed closely to the lower end part (15). Inside the piping (4) an interchangeable filter (5) is sealed which is constructed of material with pore sizes up to 100 μm.

### FIELD OF THE INVENTION

The invention relates to a method and device for producing of bubbly alcohol-containing beverages with certain content of naturally produced or introduced carbon dioxide, which have application in the food-processing industry, more specifically, in the wine-producing and brewery industries. In the wine-producing industry bubbly beverages are referred to as ‘sparkling’.

### PRIOR ART

There are known methods and devices for the producing of bubbly alcohol-containing beverages [1, 2, 3] where an initially prepared source material is subjected to controlled alcohol fermentation in an air-tight system. The outcome product is subjected to successive stabilization and filtration. The controlled alcohol fermentation processes for the producing of fermented sparkling beverages can be primary and secondary.

The primary fermentation process is an one-time process and is carried out in two stages—the first, in atmospheric conditions, and the second, carried out in an air-tight system. The process is, in its essence, a diminishing fermentation process, known in the brewing industry as “conditioning”. The latter takes into account the quantity of residual fermentable sugar and is carried out under definite pressure and temperature. The producing of beer, cider, also named sparkling apple wine, and other naturally fermented sparkling beverages is based on this method.

During the first stage of the primary fermentation the process is carried out in large-capacity tanks, equipped with sampling valves, etc., with precise temperature control ensured by complex controlling and regulating equipment. The second stage of the primary fermentation process is carried out in special rooms, in large air-tight containers, working under pressure, which are called fermentation tanks. These tanks are equipped with a cooling system, either serpentine or jacket, as well as with mixer blades or circulation pumps with the necessary piping, or with gas-injection devices, necessary for the homogenizing of the liquid. They are also equipped with safety, controlling and regulating devices for precise control and regulation of temperature and pressure.

The producing of fermented sparkling beverages is based on the secondary fermentation process in an air-tight system. This method is known as champagnization. The method represents the realization of a secondary fermentation process in an air-tight system of a ‘bottle fermentation’ or ‘bulk fermentation’ source material, containing fermentable sugar, using an actively growing pure yeast culture. The bottle fermentation is carried out in special air-tight glass bottles, with volumes as follows: quart—0.2 l, demi 0.4 l, medium—0.6 l, 0.8 l, magnum—1.6 l, jeroboam—3.2 l [symbol] mathusalem—6.4 l. The source material, containing fermentable sugar, and the necessary quantity of actively growing pure yeast culture, forming a “base mix”, are dozed into the bottle, homogenized, and then the bottle is closed air-tight with a special stopper fixed with a metal clamp. The secondary fermentation process in the bottle is carried out at rigidly controlled temperature and time parameters.

Tank fermentation is carried out in air-tight metal containers, made of stainless or black steel, whose inside is isolated by an acid-resistant coating, suitable for work with foodstuffs. They are equipped with cooling systems to provide the necessary cooling of the fermentation medium. Devices for control and regulating of temperature and pressure are necessary, as these parameters fluctuate during the process. The usual size of fermentation tanks varies from 2000 l to 5000 l. It is possible to use larger tanks, if the producing capacity requires so.

The so formed fermented sparkling wines are necessarily subjected to stabilization, aiming at achieving long-term stability of their organoleptic and colloidal structures. That is achieved by treating the newly formed products with adsorbents, flocculants, enzyme solutions etc. The resulting sparkling wines are subjected to centrifugation, filtration, using filter pads, membrane filters, etc. These processes are carried out in very difficult conditions, the aim being to preserve the qualities of the so formed sparkling wines as they pass from one device to another. To do this, it is necessary to keep the product at low temperature and provide a counter-pressure of inert gas.

In classic bottle fermentation, or “champagne method”, known also under its French name methode champenoise, stabilization is done by using various fining agents such as bentonite, gelatin, tannin etc. placed into the bottle together with the base mix. The manual practices of riddling, known also under its French name remuage, and disgorging, known also under its French name dégorgement, are used, which are labour- and time-consuming, and which require breach of the air-tightness of the bottles. This leads to: breaking up of the equilibrium of the existing gas-wine system, loss of carbon dioxide and deterioration of the organoleptic qualities of the wine. Sometimes riddling and disgorging are replaced by a method of separation of the cleared liquid from the inactivated autolyzing biomass, called transphasion. It, too, is labour-consuming and consists of transferring the ready sparkling wine from the original bottle into a new one. This leads to: breaking up of the equilibrium of the existing gas-wine system, loss of carbon dioxide and deterioration of the organoleptic qualities of the wine.

It is clear from the above that with the known methods the processes of controlled alcohol fermentation, stabilization and filtration are carried out consecutively in time and in different technological units, i.e. in different complex technological apparatuses. Besides, the tank fermentation method of champagnization is energy-consuming and requires huge investments in machinery and device. The necessary technical devices include air-tight fermentation tanks, filtering facilities, powerful cooling facilities etc. To reach the consumer, the so produced sparkling alcohol-containing beverages have to be bottled.

The disadvantages of classic bottle fermentation are that the processes are very labour- and time-consuming. The percentage of losses is excessively high, mostly with the manual practices of riddling and disgorging. Moreover, these procedures exert a negative influence on the organoleptic qualities of the wine. During the process of disgorging the long-built-up equilibrium of the gas-wine system is broken up. All these reasons provide ground for the qualification that classic bottle fermentation, or méthode champenoise, is the costliest method of bubbly wine production.

The disadvantages of tank fermentation are first and foremost in the necessity for serious investment for building up of powerful material and technical bases, required for the production of sparkling beverages. The processes are carried out by multiple passing of one and the same batch of definite volume through a multitude of separate, complex technical apparatuses. What is more, for the addition of the filling solution it is necessary to use special pressure-equalizing mixers. Concurrent coolant producing is necessary during the whole process of production. Additional producing halls have to be built and maintained for: pressure-equalizing bottling, washing facilities, storage of empties and production. It is necessary to secure a great supply of inert gas, for the required counter-pressure. The hygiene of the huge fermentation tanks and the other applications, including heat-exchangers, filters, pumps, piping etc., is difficult to maintain. This can create possibilities for infection. The losses of material are large, owing to the transfer of the processed liquid from one injto another fermentation tank, or into another specialized producing apparatus, which is done under pressure. In all these procedures negative organolepsis is produced and the colloidal stability of the beverage is worsened. Before reaching the consumer, the beverage fills up consecutively several different volumes—tanks, bottles, which is bad for the quality of the naturally sparkling beverages, where the bound form of carbon dioxide is very important, and which seriously decreases the amount of carbon dioxide so that it is necessary to restore it via additional carbonation. This is a sort of denaturalization of the natural product. It deteriorates the quality characteristics of the sparkling wines—sparkling and effervescence.

It is well known, that the popular low-alcoholic beverage—beer does not have a long-lasting resistance of its own as regards its colloidal and microbiological stability, which, in practice, necessitates its pasteurization almost everywhere. Pasteurization of bottled beer is done in technical facilities known as pasteurizing tunnels at a determined temperature and time rate. Direct pasteurization of beer is also practiced in lamelled heat-exchangers by very brief high-temperature rises, strictly controlled by precise automatics. This method is used for beer that is to be either glass-bottled, or filled into larger containers. The negative result, caused by thermal processing of whatever foodstuff or beverage, is doubtless. In this case, in order to preserve the microbiological stability of the beer, a considerable part of its organoleptic balance is lost; its biologically active ingredients like vitamins, enzymes, etc. are destroyed. Besides, the protein structure, unstable as regards thermal influence, is denaturalized, i.e, pasteurization denaturalizes any naturally-formed bubbly beverage, including beer.

The above mentioned clearly shows that a disadvantage of the known methods and devices for producing of bubbly alcohol-containing beverages is the usage of separate costly pieces of equipment, placed in different technological locations, for carrying out each technological operation: controlled alcohol fermentation, stabilization and filtration. Apart from that, a number of additional substances is used in stabilization—clearing agents, flocculants, adsorbents, preservatives. When the same volume of the produced beverage passes through the various fermentation tanks and apparatuses, as well as in pasteurization, there is a partial disintegration of the newly-formed organoleptic qualities of the bubbly alcohol-containing beverage produced.

The aim of the invention is to create simplified method and device for producing of bubbly alcohol-containing beverages, which are more cost-effective and provide preservation of the natural qualities of the bubbly alcohol-containing beverages.

### SUMMARY OF THE INVENTION

This problem is solved by a method for producing of bubbly alcohol-containing beverages where a base mix is prepared and subjected to the technological processes of controlled alcohol fermentation in an air-tight system, stabilization and filtration. According to the invention, the controlled alcohol fermentation, stabilization and filtration are carried out in one and the same air-tight space and the resultant beverage remains in that space till the moment of its consumption. The filtration and stabilization are carried out simultaneously during the beverage's being drawn out for consumption.

This problem is also solved by a method for producing of bubbly alcohol-containing beverages where a preliminarily prepared non-stabilized, non-bubbly and unfiltered alcohol-containing beverage is subjected to the technological processes of carbonation in an air-tight system, stabilization and filtration. According to the invention, the carbonation, stabilization and filtration are carried out in one and the same air-tight space and the resultant beverage remains in that space till the moment of its consumption. The filtration and stabilization are carried out simultaneously during the beverage's being drawn out for consumption.

Prior to consumption, the beverage could be conditioned, in accordance with the consumer's taste, by addition of pre-dozed filling solution, which is a sweetening dosage, usually white wine containing minimum 67% sucrose.

Prior to consumption, the beverage could also be conditioned, in accordance with the consumer's taste, by addition of pre-dozed fruit concentrate.

This problem is solved also by a device for the producing of bubbly alcohol-containing beverages, realizing the method according to the invention, consisting of a container, whose inner surface is suitable for contact with consumer beverages. According to the invention, the container 1 is one-piece, consisting of a cylindrical body and spherical upper and lower end parts. A protruding cylindrical band is fixed to both end parts of the container, above and below their joining planes so that the outer edges of the bands extend beyond the length of the container. The container and the bands together form a keg. A multifunctional plug head is fitted fixedly in the center of the said upper end part. To the head's lower part a piping is fitted fixedly, whose axis coincides with the container's. The open end of the piping is placed very close to the lower end part and inside it a filtering element is fitted. The outer lower end of the filtering element is sealed to the piping by means of a sealing ring. The filtering element is interchangeable, and, depending on the required final result, can have different strictly fixed pore dimensions.

The filtering element is made of porous material with pore size less than 100 μm and is in the form of a hollow cylinder. Its outer surface has drop-like protrusions for distancing, spaced along the said surface. The upper end of the filter is closed. The lower end of the filter is open to the volume of the container. A ring forms the lower periphery of the filter element, whose outside diameter is larger than the outer diameter of the piping. On the upper surface of the ring a bed for receiving the sealing ring is formed.

During the fermentation of the base mix the outlet of the said multifunctional plug head of the container is closed, and its inlet is connected to monitoring and controlling instruments.

During the realization of the beverage the inlet of the said multifunctional plug head of the container is connected via a reduction valve to a pressurized carbon dioxide container, and its outlet is connected to a draught outlet.

During the carbonation of a non-stabilized, non-bubbly alcohol-containing beverage, the inlet of the said multifunctional plug head of the container is connected via a reduction valve to a pressurized carbon dioxide container, its outlet is closed and the container is turned upside down.

It is possible to use the device according to the invention in combination with an available fermentation tank for the producing of non-stabilized bubbly alcohol-containing product. The inlet of the said multifunctional plug head of the container is connected to the outlet of the fermentation tank equipressurally.

The advantages of the method for producing of bubbly alcohol-containing beverages are its simplicity, enhanced efficiency and preservation of the natural qualities of the said beverages. These advantages are due mainly to the fact that all technological operations for the processing of the base mix are carried out in one and the same air-tight space without breaking up of the built-up equilibrium of the gas-beverage system until the moment of consumption, and, not least, without use of additional substances for stabilization of the beverages. In a short time a high norm of chemical and physico-chemical content of the bound form of carbon dioxide is achieved, owing to the lack of the necessity of breach of the air-tightness during the processes for the producing of fermented sparkling beverages. This leads to the preservation of all natural characteristics of the produced fermented sparkling beverages, as well as of the carbon dioxide; exclusion of the possibility of oxidation; redundancy of the necessity for pasteurization; easy hygiene maintenance of the device; compactness; significant reducing of the losses.

The advantages of the device for producing of bubbly alcohol-containing beverages are its simplicity, enhanced efficiency and the preservation of the natural qualities of the beverages owing to the fact that all processes are carried out in the container, which, apart from that, is used as package for storing, transport and realization of the beverage. In this way the use of the expensive, bulky and complex packing equipment is avoided. It is possible to use the kegs according to the invention together with a part of the available expensive apparatuses. For example, it is possible to use the above mentioned fermentation tanks in combination with the kegs according to the invention. The non-stabilized bubbly beverage is produced in the fermentation tank, but the stabilization and filtration are carried out in the kegs according to the invention, in which the beverage is stored, transported and realized.

### BRIEF DESCRIPTION OF THE DRAWINGS

The invention is explained more detailed with embodiments, shown on the attached drawings, where

FIG. 1 is a perspective view of the device for producing of bubbly alcohol-containing beverages according to the invention;

FIG. 2 is a vertical section drawing along the axis I-I of the multifunctional plug head 3 of the device 16 of FIG. 1;

FIG. 3 is a enlarged perspective view of the filter 5 from FIG. 2;

FIG. 4a is a technological scheme for use of the device 16 as a fermentation tank;

FIG. 4b is a perspective view of the device 16, used as packing for storage and transportation;

FIG. 5 is a technological scheme for use of the device 16 as a device for filtration and realization of the ready beverage;

FIG. 6 is a technological scheme for use of the device 16 as packing for storage and transportation of a fermentation-tank-produced beverage;

FIG. 7 is a technological scheme for use of the device 16 according to the invention as a carbonation column.

### DETAILED DESCRIPTION OF THE INVENTION

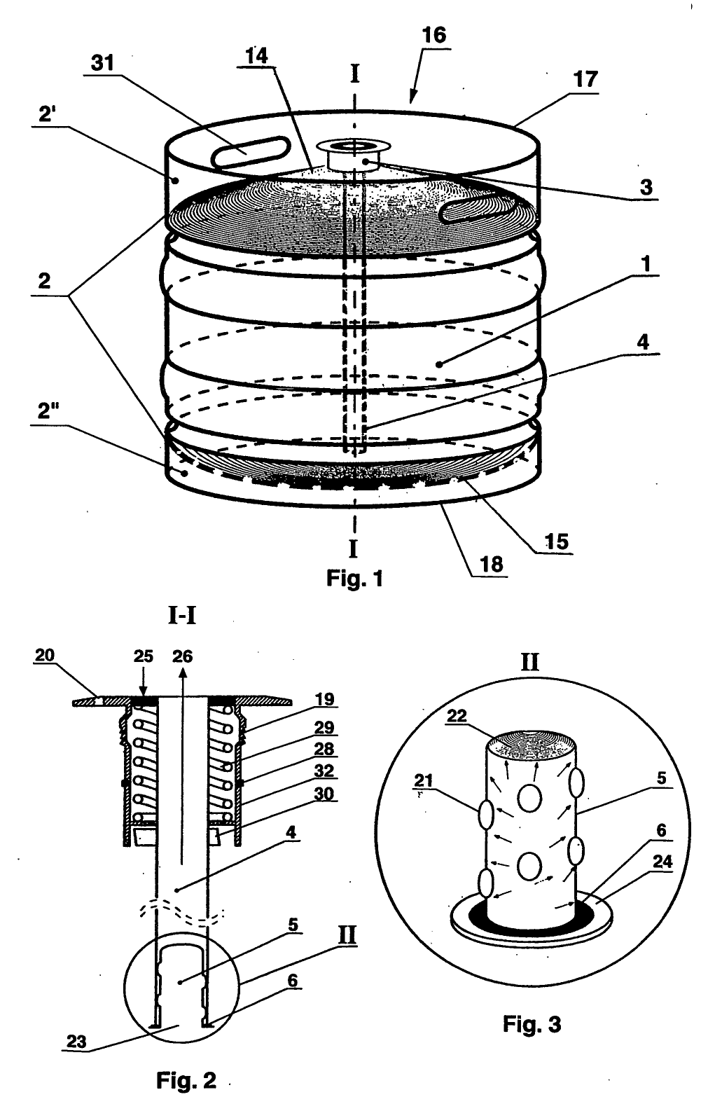

The device for producing of bubbly alcohol-containing beverages shown on FIG. 1 consists of a container 1, whose inner surface is approved for contact with foodstuff and beverages, for example, stainless steel for the food-processing industries. The container 1 is one-piece, consisting of a cylindrical body and spherical upper 14 and lower 15 end parts. A protruding cylindrical band 2 is fixed to the both end parts of the container. Said band 2 can be one-piece, or consisting of upper part 2′ and lower part 2″, joined respectively above and below the joining planes of the end parts 14 and 15 to the cylindrical surface of the container 1, so that the outer edges 17 and 18 of the bands 2′ and 2″ extend beyond the length of the container 1. The container 1 and the band 2 together form a keg 16 with a volume from 5 to 65 l, capable of withstanding working pressure of up to 0.55 MPa. On the surface of the upper cylindrical band 2′ there are opposite openings 31 (FIG. 1), for easier handling and storing of the kegs 16. A multifunctional plug head 3 is fitted fixedly in the center of the upper end part 14, for example threaded 19, and screwed in using the pinhole 20. The lower end 15 of the head 3 is fixed to piping 4, whose axis coincides with that of the container 1. The lower open end of the piping 4 is placed very close to the lower end part 15. Inside the lower open end of the piping 4 a filtering element 5 is fitted, whose outer lower end is sealed to the piping 4 by means of a sealing ring 6.

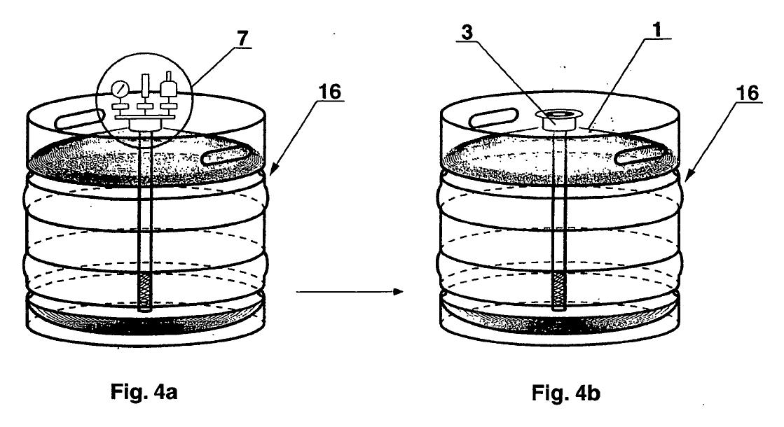

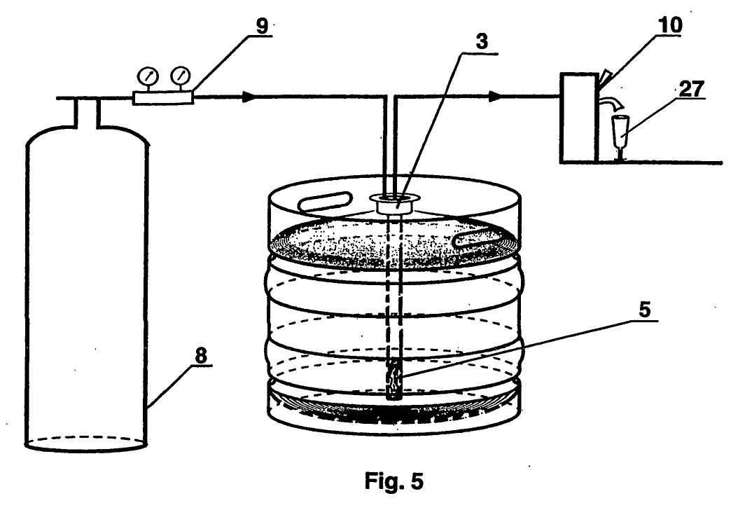

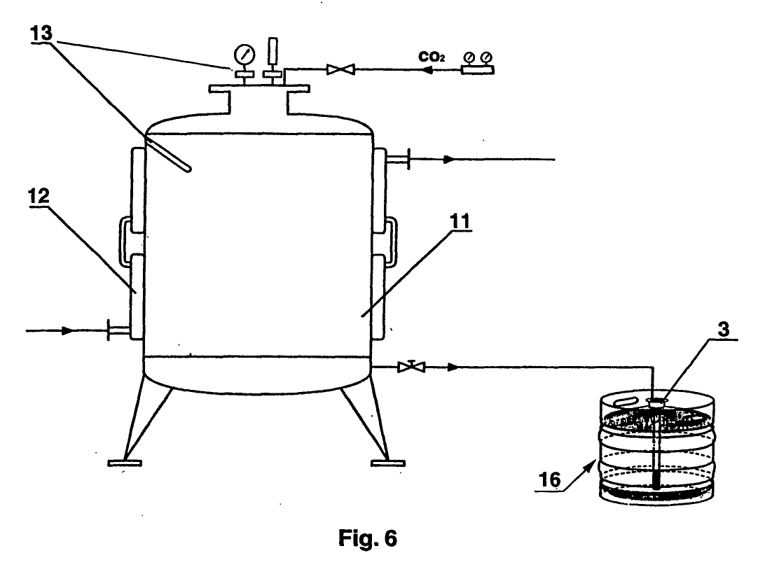

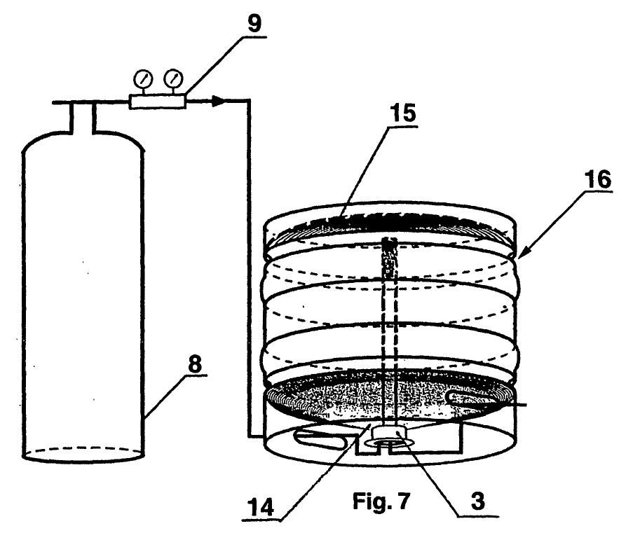

The multifunctional plug head 3 is an available technical device. In practice, it is standardized and is produced by various manufacturers throughout the world. One of those manufacturers is the Italian Company “Nuti & C.S.p.A.” [4]. A standard fitting of “Nuti & C.S.p.A”, not shown on the figures, is provided for the head 3, which allows opening and closing of the inlet 25 and outlet 26 of the multifunctional plug head 3 (FIG. 2). The head 3 of the keg 16 (FIG. 2) is fixed to the upper end part 14 of the keg 16 (FIG. 1) by a thread 19 (FIG. 2) and is screwed in with a standard wrench of “Nuti & C.S.p.A.”, not shown in the Figures, using the pinhole 20. The standard fitting utilizes not shown in the Figures standard pliable hoses and stop valves of “Nuti & C.S.p.A.”, capable of withstanding high pressure and fitted with standard connection sockets. It functions as a connective element of the inlet 25 and outlet 26 of the multifunctional plug head 3 (FIG. 2) to: monitoring and control devices, e.g. pressure gauge, safety valve, 7 (FIG. 4a); pressurized carbon dioxide container 8, via a reduction valve 9 (FIGS. 5 and 7); fermentation tank 11, with cooling jacket 12 and monitoring and control devices 13 (FIG. 6); draught outlet 10 (FIG. 5). The standard fitting is operated manually depending on the chosen function of the keg 16. The multifunctional plug head 3 is equipped with a spring 29, held by a fixing element 30 (FIG. 2), within a cylindrical shell 32, whose axis coincides with the axis of the piping 4. Openings 28 are made in the shell 32, connecting the inlet 25 of the head 3 with the internal part of the container 1 (FIG. 2).

The filtering element 5 (FIGS. 2 and 3) is made of porous material, e.g. porcelain or synthetic polymer, with pore size less than 100 μm. The pore size of the filter element 5 is chosen in accordance with the result aimed at. The filter element can be disposable or reusable. It is in the form of a hollow cylinder. Its outer surface has drop-like protrusions for distancing, 21 (FIG. 3), spaced along the said surface. The upper end 22 of the filter 5 is closed; the lower end 23 is open to the container 1. In working condition the tops of the drop-like protrusions 21 (FIG. 3) fit closely against the inner surface of the piping 4 (FIG. 2). Along the lower periphery of the filter element 5 a ring 24 is formed (FIG. 3), whose outer diameter is larger than the outer diameter of the piping 4 (FIG. 2). On the upper surface of the ring 24 a bed is formed for receiving the sealing ring 6 (FIG. 3).

The exploitation of the device for the producing of bubbly alcohol-containing beverages according to the invention is as follows:

The prepared base mix, containing a fixed amount of fermentable sugar and the requisite quantity of pure yeast culture, liquid, dry or immobilized, is fed into the container 1, with the multifunctional plug head 3 removed. Then it is closed air-tight by the multifunctional plug head 3. Monitoring and controlling equipment 7 are connected to its inlet 25. The outlet 26 of the head 3 is closed (FIG. 4a). Within a brief period a high norm of chemical and physico-chemical content of the bound form of carbon dioxide is achieved, owing to the lack of breach of the air-tightness during the processes for producing of bubbly alcohol-containing beverages. After the completion of fermentation the monitoring and controlling equipment 7 are removed from the multifunctional plug head 3, the inlet 25 is closed automatically by the spring 29 (FIG. 2, 4b) and the space inside the container 1 is kept air-tight. The resultant beverage remains within this air-tight space until the moment of its consumption. This is a factor for the preservation of the natural components and the organoleptic qualities of the produced beverage, as the so-formed high pressure inhibits the active microbiological processes, stimulating positive enzyme processes leading to the accumulation of biologically active substances. The stabilization and filtration of the beverage are carried out simultaneously during the realization of the beverage (FIG. 5). During the realization of the beverage the inlet 25 of the multifunctional plug head 3 of the keg 16 is connected via a reduction valve 9 to a gas container 8, containing pressurized carbon dioxide. The outlet 26 of multifunctional plug head 3 is connected to a draught outlet 10.

By opening of the outlet 26 of the multifunctional plug head 3 the ready non-stabilized and unfiltered beverage is moved by the higher pressure in the container 8 through the lower opening 23 of the piping into the filter 5. The beverage passes through the pores of the filter 5 and enters the piping 4 stabilized and filtered., After that through the outlet 26 of the multifunctional plug head 3 the stabilized and filtered beverage goes on to the draught outlet 10, and from there into the consumption vessel 27 (FIG. 5).

Before consumption the beverage can be conditioned, in accordance with the consumer's taste, by the addition into the consumption vessel 27 of pre-dozed filling solution, or fruit concentrate.

It is possible to use the device 16 according to the invention in combination with an available fermentation tank. In this case the multifunctional plug head 3 of the keg 16 is connected equipressurally through its inlet 25 to the outlet of the fermentation tank 11, containing the non-stabilized bubbly alcohol-containing beverage (FIG. 6). The device 16 functions as package for storing and transportation, reactor for stabilization, filtering equipment and packing for the sale of the ready beverage.

Inside the proposed device carbonation of a non-bubbly beverage can be carried out. It is done at low temperature, e.g. within the interval +1° C. to +3° C. In this case the device 16 functions as a carbonation column. During the carbonation the inlet 25 of the multifunctional plug head 3 of the keg 16 is connected via a reduction valve 9 to a gas container 8, containing pressurized carbon dioxide and the outlet 26 is closed. The keg 16 is turned upside down (FIG. 7).

The method and device according to the invention can also be utilized with a pre-stabilized base mix. In this case the removal of newly-formed, as a result of the processes going on in the container, substances of colloidal character, which cause turbidization of the bubbly alcohol-containing beverage, is guaranteed.

The method, according to the invention, can even be utilized without the use of the filtering element 5 (FIGS. 1, 2), when the aim is to produce a non-stabilized, unfiltered bubbly alcohol-containing beverage or an immobilized pure yeast culture has been used.

It can clearly be seen from the above, that the device for the producing of bubbly alcohol-containing beverages 16 functions consecutively as: fermentation tank (FIG. 4a), a reactor where diminishing fermentation processes are carried out (FIG. 4b), packing for storage, transportation and for the sale of the ready beverage (FIGS. 1, 4b and 6), carbonation column (FIG. 7), filtering equipment, reactor for the stabilization of the beverage (FIG. 5).

The inventor has experimented the method and device for producing of bubbly alcohol-containing beverages according to the invention in industrial conditions. The following materials were used for the preparation of the base mix:
dry, white, non-stabilized wine material from the “Riesling” grape, which had undergone a preliminary rough diatomaceous earth, or Kieselguhr filtration;
wine solution of sucrose with concentration 64%;
liquid cold-resistant pure yeast culture (Saccharomyces oviformis), strain “Varna 1”, added in quantity 7% of the volume of the source material.

The source material was prepared in a quantity of 3100 l, which was been fed into a mixing container with 3500 l capacity. The container was made of stainless steel approved for contact with foodstuff and had a propeller mixer and the requisite inlet and outlet fittings. 103 kg wine solution of sucrose were added, which provides 21 g fermentable sugar per liter of source material.

After the homogenization of the conditioned source material, it was apportioned into 100 metal kegs 16 according to the invention, with working capacity 30 l each (FIG. 1). Each keg 16 was filled with 27.3 l conditioned source material and 2.05 l liquid pure yeast culture was added. In the container 1 of the keg 16 an empty space forming a gas camera was left, representing 2.3% of the volume of the container 1.

The so-filled with the base mix kegs 16 (FIG. 1) were closed air-tightly by screwing-in and fixing of the multifunctional plug head 3 to the keg 16 (FIG. 1). Before closing, a filtering element 5 with pore-size 3 μm was fitted and sealed in the piping 4. (FIG. 2).

The so-prepared kegs 16 were homogenized by manual shaking and stored in a hall where the temperature could be regulated and strictly controlled.

Randomly chosen 3 kegs 16 of the batch were fitted with monitoring and controlling equipment 7 (FIG. 4a). During the time when the secondary fermentation process was being carried out in the air-tight space of the containers 1, the kegs 16 (FIGS. 1, 4a) were placed under equal conditions.

A secondary fermentation process was carried out with duration of 23 days at temperature rates as follows:
6 days at temperature 18° C.,
4 days at temperature 17° C.,
4 days at temperature 16° C.,
4 days at temperature 15° C.,
1 day at temperature 14° C.,
1 day at temperature 13° C.,
3 days at temperature 12° C.

As a result of the process the pressure of the carbon dioxide inside the container 1 of the keg 16 built up to 0.41 MPa (FIGS. 1, 4a).

After that the resultant fermented sparkling wine was stored in the same hall and in the same kegs 16 at temperatures between 14° C. and 16° C. for 90 days.

After that the monitoring and controlling equipment 7 was removed from the 3 monitored kegs (FIG. 4b) and the ready wine was realized. A standard fitting of “Nuti & C.S.p.A.” was fixed to the multifunctional plug head 3 and via standard pliable hoses and stop valves of “Nuti & C.S.p.A.” the connections were made to the pressurized carbon dioxide container 8, via a reduction valve 9 and to the draught outlet 10 (FIG. 5) at a temperature of realization and consumption 9° C.

The specific properties characterizing the fermented sparkling wine produced as above were as follows:
1. sparkling and bubbly properties:
1.1. Vₘₐₓ^{co}₂=2273 cm^{3,}
1.2. t_{mac}×=395 min,
1.3. 0.75 Vₘₐₓ=1835 cm³/t₁=85 min/,
1.4. 0.5 Vₘₐₓ=1990 cm³/t₂=23 min/,
1.5. c=0.194,
1.6. m=1.92
2. total carbon dioxide 8.5 g/l,
3. bound carbon dioxide 1.75 g/l.

As can be seen, the bound form of carbon dioxide is almost 21%, which is a rare achievement for the quantity of bound carbon dioxide in fermented sparkling wines. This could be explained with the avoidance of breach of the air-tightness during the process of producing of the fermented sparkling wine.

### REFERENCES

1. Marinov, Marin, Technology of wine and alcohol beverages, 1990, (in Bulgarian), pp.124-139; Zemizdat, Sofia, Bulgaria
2. Velkov, Emil, Encyclopedia of alcohol beverages, 1996, (in Bulgarian), pp.452-454; Sofia, Bulgaria
3. P. G. Gargolio. La nuova enologia, III edizione, 1965, Firenze—Piazzale delle, Cascine, 28, pp 418-443;
4. Catalogue of “Nuti & C.S.p.A.” address Via S. Quirico 282-50010 Capalle-Campi Bisenzio (FI) Italia, based in Germany “Nuti” G.m.b.H., Zum Schuermannsgraben 12 B—47441 Moers Deutschland, Internet: http://www.nuti.it—1999.

1. Method for industrial producing of bubbly alcohol-containing beverages where a base mix is prepared and subsequently subjected to controlled alcohol fermentation in an air-tight system, stabilization and filtration, characterized by the fact that the alcohol fermentation, stabilization and filtration are carried out in one and the same air-tight space and the resultant bubbly beverage remains in that space till the moment of its consumption, when the filtration and stabilization are carried out simultaneously.

2. Method for industrial producing of bubbly alcohol-containing beverages where a preliminarily prepared non-stabilized, non-bubbly and unfiltered alcohol-containing beverage is subsequently subjected to carbonation in an air-tight system, stabilization and filtration, characterized by the fact that the carbonation, stabilization and filtration are carried out in one and the same air-tight space and the resultant bubbly beverage remains in that space till the moment of its consumption, when the filtration and stabilization are carried out simultaneously.

3. Method for industrial producing of bubbly alcohol-containing beverages according to claims 1 and 2, characterized by the fact that prior to consumption, the beverage is conditioned, in accordance with the consumer's taste, by addition of pre-dozed filling solution.

4. Method for industrial producing of bubbly alcohol-containing beverages according to claims 1 and 2, characterized by the fact that prior to consumption, the beverage is conditioned, in accordance with the consumer's taste, by addition of pre-dozed fruit concentrate.

5. Method for industrial producing of bubbly alcohol-containing beverages where a pre-stabilized, clarified and filtered base mix is prepared, containing the necessary quantities of fermentable sugar and pure yeast culture, which is subsequently subjected to controlled alcohol fermentation in an air-tight system, characterized by the fact that the pure yeast culture in the base mix is immobilized, the resultant bubbly beverage remains in the air-tight space where it had fermented until the moment of its consumption.

6. Method for industrial producing of bubbly alcohol-containing beverages where a preliminarily prepared, non-bubbly, stabilized, and filtered alcohol-containing beverage is subsequently subjected to carbonation in an air-tight system, characterized by the fact that the resultant bubbly beverage remains in the air-tight space where it had been carbonated until the moment of its consumption.

7. A device for industrial production of bubbly alcohol-containing beverages, realizing the method under claims 1 and 2, consisting of a container, whose inner surface is suitable for contact with foodstuffs, and whose upper part has an opening, in which a plug head has been screwed tight, continuing in piping whose axis coincides with the container's, the lower end of the piping being very close to the bottom end of the container and being fitted with a filtering element, characterized by the fact that the container (1) is a standard metal cylindrical keg with spherical upper (14) and lower (15) ends, the plug head (3) is a standard multifunctional head, and the filtering element (5) is fitted inside the piping (4), sealed to its lower end by a sealing ring (6).

8. Device according to claim 7, characterized by the fact that the filtering element (5) is made of porous material with pore size less than 100 μm and is formed as a hollow cylinder whose outer surface is provided with a multitude of distancing drop-like protrusions (21), spaced along the its surface, the upper end (22) of the said filter (5) is closed, the lower end (23) of the said filter (5) is open to the volume of the container (1), along the lower periphery on the outside of the said filter element (5) a ring (24) is formed, whose outer diameter is larger than the outer diameter of the piping (4), and on the upper surface of the said ring (24) a bed is formed receiving the said sealing ring (6).

9. Device according to the claims 7 and 8, characterized by the fact that the inlet (25) of the multifunctional plug head (3) of the keg (16) is connected to monitoring and controlling devices (7), and the outlet (26) of the said head (3) is closed.

10. Device according to the claims 7 and 8, characterized by the fact that the inlet (25) of the said multifunctional plug head (3) of the said keg (16) is connected via a reduction valve (9) to a gas container (8) containing pressurized carbon dioxide, the outlet (26) of the said head (3) is closed, and the keg (16) is turned with its lower end (15) up.

11. Device according to the claims 7 and 8, characterized by the fact that the inlet (25) of the multifunctional plug head (3) of the keg (16) is connected equipressurally to the outlet of a fermentation tank (11), containing non-stabilized bubbly alcohol-containing beverage.

12. Device according to the claims 7 and 8, characterized by the fact that said protruding cylindrical band (2) consists of upper part (2′) and lower part (2″) fixed, respectively, above and below the joining planes of the end parts (14 and 15) to the cylindrical surface of the container (1), so that the outer edges (17 and 18) of the bands (2′, 2″) extend beyond the length of the said container (1), and the upper cylindrical band 2′ is provided with opposite openings 31.

13. Device for industrial producing of bubbly alcohol-containing beverages, realizing the method according to claims 5 and 6 consisting of a container, whose inner surface is suitable for contact with foodstuffs, and whose upper part has an opening, in which a plug head has been screwed tight, continuing in piping whose axis coincides with the container's, the lower end of the piping being very close to the bottom end of the container, characterized by the fact that the container (1) is a standard metal cylindrical keg with spherical upper (14) and lower (15) ends, and the plug head is a standard multifunctional head (3).
